(19) United States
(12) Patent Application Publication
(10) Pub. No.: US 2015/0159022 A1
(43) Pub. Date: Jun. 11, 2015

(54) Composition For Surface Treatment, Method Of Preparing A Surface-Treated Article, And Surface-Treated Article

(71) Applicant: Dow Corning Corporation, Midland, MI (US)

(72) Inventors: Michael L. Bradford, Midland, MI (US); Brian Robert Harkness, Midland, MI (US); Hyun Daesup, Kyunggido (KR); Ryan Frederick Schneider, Midland, MI (US)

(73) Assignee: Dow Corning Corporation, Midland, MI (US)

(21) Appl. No.: 14/405,804

(22) PCT Filed: Jul. 10, 2013
(86) PCT No.: PCT/US2013/049941

§ 371 Date: Dec. 5, 2014

Related U.S. Application Data
(60) Provisional application No. 61/670,947, filed on Jul. 12, 2012.

(51) Int. Cl. C09D 5/16

(52) U.S. Cl. CPC C09D 5/16

(57) ABSTRACT

A composition comprises a perfluorinated solvent having at least one CF3 group selected from a perfluoropolyether solvent having a boiling point temperature of at least 120° C. at atmospheric pressure and a nitrogen-containing perfluorinated solvent. The composition further comprises a polyfluoropolyether silane. The composition forms layers having excellent physical properties, including durability and appearance, in addition to stain and smudge resistance.

### FIELD OF THE INVENTION

The present invention generally relates to a composition for surface treatment and, more specifically, to a composition comprising a polyfluoropolyether silane and a solvent, a method of preparing a surface-treated article with the composition, and the surface-treated article formed therefrom.

### DESCRIPTION OF THE RELATED ART

Surfaces of electronic and optical devices/components are susceptible to staining and smudging, oftentimes due to oils from hands and fingers. For example, electronic devices including an interactive touch-screen display, e.g. smart phones, are generally smudged with fingerprints, skin oil, sweat, cosmetics, etc., when used. Once these stains and/or smudges adhere to the surfaces of these devices, the stains and/or smudges are not easily removed. Moreover, such stains and/or smudges decrease the usability of these devices.

In an attempt to minimize the appearance and prevalence of such stains and smudges, conventional surface treatment compositions have been applied on the surfaces of various devices/components to form conventional layers. However, once applied on the surfaces of these devices/components, conventional surface treatment compositions often leave an undesirable and uneven appearance. For example, conventional layers formed from conventional surface treatment compositions generally include undesirable streaks. Accordingly, the surfaces of such devices/components are generally rinsed after application of conventional surface treatment compositions, thus requiring additional processing steps, cost, and time, while decreasing durability of the conventional layers due to the additional step of rinsing the conventional layers.

### SUMMARY OF THE INVENTION AND ADVANTAGES

The present invention provides a composition for surface treatment. The composition comprises a perfluorinated solvent having at least one CF₃ group. In certain embodiments, the solvent comprises a perfluoropolyether solvent having a boiling point temperature of at least 120° C. at atmospheric pressure and having the following general formula (A):

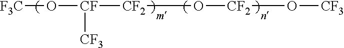

wherein m′ is an integer ≧1 and n′ is ≧0. In other embodiments, the solvent comprises a nitrogen-containing perfluorinated solvent having the following general formula (B):

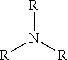

wherein each R is an independently selected perfluorinated C₁-C₁₀ group. Alternatively, the solvent of the compositions may comprise combinations of such perfluoropolyether solvents and nitrogen-containing perfluorinated solvents. The composition further comprises a polyfluoropolyether silane having the following general formula (C):
Y—Z_{a′}—[(OC₃F₆)_{b}—(OCF(CF₃)CF₂)_{c}—(OCF₂CF(CF₃))_{d}—(OC₂F₄)ₑ—(CF(CF₃))_{f}—(OCF₂)_{g}]—(CH₂)ₕ—X′—(CₙH₂ₙ)—((SiR¹₂—O)ₘ—SiR¹₂)ᵢ—(CⱼH₂ⱼ)—Si—(X″)_{3-z}(R²)_{z};
wherein Z is independently selected from —(CF₂)—, —(CF(CF₃)CF₂O)—, —(CF₂CF(CF₃)O)—, —(CF(CF₃)O)—, —(CF(CF₃)CF₂)—, —(CF₂CF(CF₃))—, and —(CF(CF₃))—;
a′ is an integer from 1 to 200; b, c, d, e, f, and g are integers each independently selected from 0 to 200; h, n and j are integers each independently selected from 0 to 20; i and m are integers each independently selected from 0 to 5; X′ is a bivalent organic group or an oxygen atom; R¹ is an independently selected C₁-C₂₂ hydrocarbon group; z is an integer independently selected from 0 to 2; X″ is an independently selected hydrolysable group; R² is an independently selected C₁-C₂₂ hydrocarbon group which is free of aliphatic unsaturation; and Y is selected from F and Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—; wherein X″, X′, z, R¹, R², j, m, i, n and h are as defined above; provided that when subscript i is 0, subscript j is also 0; when subscript i is an integer greater than 0, subscript j is also an integer greater than 0; and when subscript i is an integer greater than 0, m is also an integer greater than 0.

The present invention also provides a method of preparing a surface-treated article. The method comprises applying the composition on a surface of an article to form a layer on the surface of the article from the composition. The present invention also provides a surface-treated article formed in accordance with the method.

The composition forms layers having excellent physical properties, including stain and smudge resistance. Further, the layers formed from the composition are substantially uniform and free from streaks, which generally are predominant in conventional layers formed from conventional compositions. Accordingly, layers formed from the composition need not undergo further rinsing or other additional steps typically relied upon to reduce the appearance of streaks in conventional layers formed from conventional compositions.

### BRIEF DESCRIPTION OF THE DRAWINGS

Other advantages and aspects of this invention may be described in the following detailed description when considered in connection with the accompanying drawings wherein:

FIG. 1 is an optical microscopic image of a layer formed from a composition of the disclosure at 37.5× magnification;

FIG. 2 is an optical microscopic image of a layer formed from another composition of the disclosure at 37.5× magnification;

FIG. 3 is an optical microscopic image of a layer formed from yet another composition of the disclosure at 37.5× magnification;

FIG. 4 is an optical microscopic image of a conventional layer formed from a conventional composition at 37.5× magnification;

FIG. 5 is an optical microscopic image of a conventional layer formed from another conventional composition at 37.5× magnification; and

FIG. 6 is an optical microscopic image of a conventional layer formed from yet another conventional composition at 37.5× magnification.

### DETAILED DESCRIPTION OF THE INVENTION

The present invention provides a composition for surface treatment, a surface-treated article, and a method of preparing the surface-treated article. The composition forms layers having excellent physical properties, including durability and resistance to smudging and/or staining. Further, layers formed from the composition have a desirable appearance that is generally free from spotting or streaks, which are associated with conventional layers formed from conventional compositions.

The composition comprises a perfluorinated solvent having at least one CF₃ group. The solvent is selected from the group consisting of a perfluoropolyether solvent, a nitrogen-containing perfluorinated solvent, and combinations thereof. Each of these solvents is described in greater detail below. The solvent generally at least partially solubilizes, alternatively solubilizes, the polyfluoropolyether silane. For example, the polyfluoropolyether silane may be added dropwise into the solvent to determine whether the solvent at least partially solubilizes the polyfluoropolyether silane by visual inspection. More specifically, the polyfluoropolyether silane generally disperses within the solvent, although the composition may be hazy or cloudy depending on how well the solvent solubilizes the polyfluoropolyether silane. Typically, the solvent has excellent solubility with respect to the polyfluoropolyether silane.

In certain embodiments, the solvent comprises the perfluoropolyether solvent. The perfluoropolyether solvent has a boiling point temperature of at least 120° C. at atmospheric pressure. In one specific embodiment, the perfluoropolyether solvent has a boiling point temperature of from 125 to 145, alternatively from 130 to 140, ° C. at atmospheric pressure. In another specific embodiment, the perfluoropolyether solvent has a boiling point temperature of from 160 to 180, alternatively from 165 to 175, ° C. at atmospheric pressure. Depending on the molecular weight of the perfluoropolyether solvent, the boiling point temperature of the perfluoropolyether solvent may be greater than the upper range of 180° C., e.g. to the boiling point temperature may be at least 200, 230, or 270° C.

In embodiments in which the solvent comprises the perfluoropolyether solvent, the solvent of the composition has the following general formula (A):

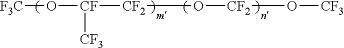

wherein m′ is an integer greater than 1 and n′ is 0 or greater. Specifically, subscripts m′ and n′ of general formula (A) above are chosen so as to provide the desired boiling point temperature of the perfluoropolyether solvent. In particular, the relationship between subscripts m′ and n′, the boiling point temperature, and the molecular weight of the perfluoropolyether solvent is set forth below:

| Boiling Point | Typical | Typical | Average |
|---|---|---|---|
| (° C.) | m′ | n′ | MW (Da) |
| 125-145 | 1-3 | 1-7 | 600-620 |
| 160-180 | 1-4 | 1-10 | 750-770 |
| 190-210 | ≧1 | ≧1 | 860-880 |
| 220-240 | ≧1 | ≧1 | 1010-1030 |
| 260-280 | ≧1 | ≧1 | 1540-1560 |

In other embodiments, the solvent comprises the nitrogen-containing perfluorinated solvent. The nitrogen-containing perfluorinated solvent has the following general formula (B):

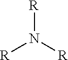

wherein each R is an independently selected perfluorinated hydrocarbon group having from 1 to 10, alternatively from 2 to 8, alternatively 3 to 5, carbon atoms.

Although each R of the nitrogen-containing perfluorinated solvent is independently selected from perfluorinated C₁-C₁₀ groups, in certain embodiments, each R of the nitrogen-containing perfluorinated solvent is identical, i.e., these substituents have the same number of carbon atoms. As but one example of such a nitrogen-containing perfluorinated solvent, a structure representative of C₁₂F₂₇N in which each R has 4 carbon atoms is set forth below for illustrative purposes only:

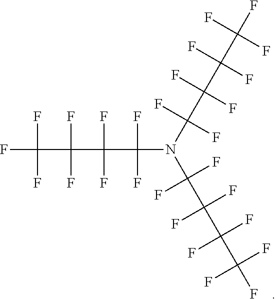 [SMILES: FC(F)(F)C(F)(F)C(F)(F)C(F)(F)N(C(F)(F)C(F)(F)C(F)(F)C(F)(F)F)C(F)(F)C(F)(F)C(F)(F)C(F)(F)F]

The solvent may comprise any combination of solvents including the perfluoropolyether solvent and/or the nitrogen-containing perfluorinated solvent. For example, the perfluoropolyether solvent may be utilized in concert with the nitrogen-containing perfluorinated solvent. Alternatively, the perfluoropolyether solvent and/or the nitrogen-containing perfluorinated solvent may be utilized in combination with one another and/or with other solvents.

Regardless of the particular solvent employed in the composition, the solvent is typically present in the composition in an amount of from 95 to 99.99, alternatively from 97.35 to 99.95, alternatively from 99.7 to 99.9, percent by weight based on the total weight of the composition. The amount of the solvent may vary from the ranges set forth immediately above contingent on the absence or presence of various optional components employed in the composition, as described in greater detail below.

The composition further comprises a polyfluoropolyether silane. The polyfluoropolyether silane has the following general formula (C): Y—Z_{a′}—[(OC₃F₆)_{b}—(OCF(CF₃)CF₂)_{c}—(OCF₂CF(CF₃))_{d}—(OC₂F₄)ₑ—(CF(CF₃))_{f}—(OCF₂)_{g}]—(CH₂)ₕ—X′—(CₙH₂ₙ)—((SiR₂—O)ₘ—SiR¹₂)ᵢ—(CⱼH₂ⱼ)—Si—(X″)_{3-z}(R²)_{z}. The groups represented by subscripts b-g, i.e., the groups within the square brackets in formula (C), may be present in any order within the polyfluoropolyether silane, including a different order as that which is represented in general formula (C) above and throughout this disclosure. Moreover, these groups may be present in randomized or block form. In addition, the group represented by subscript b is typically linear, i.e., the group represented by subscript b may alternatively be written as (O—CF₂—CF₂—CF₂)_{b}. In the description below, Cₚ-C_{q} (with p and q each being integers) regarding a hydrocarbon or alkyl group means such group has from p to q carbon atoms.

In general formula (C) above, Z is independently selected from —(CF₂)—, —(CF(CF₃)CF₂O)—, —(CF₂CF(CF₃)O)—, —(CF(CF₃)O)—, —(CF(CF₃)—CF₂)—, —(CF₂—CF(CF₃))—, and —(CF(CF₃))—. Z is typically selected such that the polyfluoropolyether silane does not include an oxygen-oxygen (O—O) bond within the backbone. In addition, in this general formula, a′ is an integer from 1 to 200; b, c, d, e, f, and g are integers each independently selected from 0 or from 1 to 200; h, n and j are integers each independently selected from 0 or from 1 to 20; i and m are integers each independently selected from 0 or from 1 to 5; X′ is a divalent organic group or an oxygen atom; R¹ is an independently selected C₁-C₂₂ hydrocarbon group; z is an integer independently selected from 0 to 2; X″ is an independently selected hydrolysable group; R² is an independently selected C₁-C₂₂ hydrocarbon group which is free of aliphatic unsaturation; and Y is selected from F and Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—; wherein X″, X′, z, R², R¹, j, m, i, n and h are as defined above.

R¹, which is an independently selected C₁-C₂₂ hydrocarbon group, may be linear, branched, or cyclic. In addition, R¹ may include heteroatoms within the hydrocarbon group, such as oxygen, nitrogen, sulfur, etc., and may be substituted or unsubstituted. Typically, R¹ is a C₁-C₄ alkyl group. In addition, the groups represented by subscripts n and j, i.e., groups (CₙH₂ₙ) and (CⱼH₂ⱼ), may also be independently linear or branched. For example, when n is 3, these groups may independently have the structure —CH₂—CH₂—CH₂, —CH(CH₃)—CH₂, or —CH₂—CH(CH₃), wherein the latter two structures have pendent alkyl groups, i.e., these structures are branched and not linear.

With respect to the moieties represented by subscripts m, i and j: when subscript i is 0, subscript j is also 0; when subscript i is an integer greater than 0, subscript j is also an integer greater than 0; and when subscript i is an integer greater than 0, m is also an integer greater than 0. Said differently, when the group represented by subscript i is present, the group represented by subscript j is also present. The inverse is also true, i.e., when the group represented by subscript i is not present, the group represented by subscript j is also not present. In addition, when i is an integer greater than 0, the group represented by subscript m is present, and m is also an integer greater than 0. In certain embodiments, subscripts m and i are each 1. Typically, the subscript i does not exceed 1, although the subscript m may be an integer greater than 1 such that siloxane bonds (i.e., Si—O bonds) are present within the group represented by subscript i.

The polyfluoropolyether silane of the composition is subject to the proviso that when Y is F; Z is —(CF₂)—; a′ is an integer from 1 to 3; and subscripts c, d, f and i are 0.

The hydrolysable group represented by X″ in general formula (C) of the polyfluoropolyether silane is independently selected from a halide group, an alkoxy (—OR³) group, an alkylamino (—NHR³ or —NR³R⁴) group, a carboxy (—OOC—R³) group, an alkyliminoxy (—O—N═CR³R⁴) group, an alkenyloxy (O—C(═CR³R⁴)R⁵) group, or an N-alkylamido (—NR³COR⁴) group, wherein R³, R⁴ and R⁵ are each independently selected from H and a C₁-C₂₂ hydrocarbon group. When R³, R⁴ and R⁵ are independently C₁-C₂₂ hydrocarbon groups, R³, R⁴ and R⁵ may be linear, branched, or cyclic. In addition, R³, R⁴ and R⁵ may independently include heteroatoms within the hydrocarbon group, and may be substituted or unsubstituted. Typically, R³, R⁴ and R⁵ are each independently selected C₁-C₄ alkyl groups. In certain embodiments, the hydrolys able group represented by X″ in general formula (C) is independently selected from an alkoxy (—OR³) group and an alkylamino (—NHR³ or —NR³R⁴) group. When the hydrolys able group represented by X″ in general formula (C) is an alkylamino group, R³ and R⁴ optionally can form a cyclic amine in the alkylamino group.

Non-limiting, exemplary embodiments of particular species of the polyfluoropolyether silane of the composition are described in detail below. Typically in these embodiments, z is 0 such that polyfluoropolyether silane includes three hydrolysable groups represented by X″. However, as described above, z can be an integer other than 0 (e.g. 1 or 2) such that these particular polyfluoropolyether silanes include fewer than three hydrolysable groups.

In certain embodiments, Y in general formula (C) is F. Typically, when Y in general formula (C) is F, subscripts c, d and g in general formula (C) are 0. As such, in these embodiments, when the groups represented by subscripts c, d and g are absent, the polyfluoropolyether silane has the general formula Y—Z_{a′}—[(OC₃F₆)_{b}—(OC₂F₄)ₑ—(CF(CF₃))_{f}]—(CH₂)ₕ—X′—(CₙH₂ₙ)—((SiR¹₂—O)ₘ—SiR¹₂)ᵢ—(CⱼH₂ⱼ)—Si—(X″)_{3-z}(R²)_{z}.

In one embodiment of the composition in which Y in general formula (C) is F, as introduced above, Z in general formula (C) is —(CF₂)—, subscripts c, d, f and g in general formula (C) are 0 and subscripts b, e, h and n in general formula (C) are each independently an integer greater than 0. As but one example of this embodiment, subscript a′ is 3, subscript b is at least 1, subscript e is 1, subscript h is 1, X′ is an oxygen atom, subscript n is 3, and subscripts m, i and j are each 0. In this one example, the polyfluoropolyether silane has the following general formula: CF₃—CF₂—CF₂—(O—CF₂—CF₂—CF₂)_{b}—O—CF₂—CF₂—CH₂—O—CH₂—CH₂—CH₂—Si—(X″)_{3-z}(R²)_{z}. Thus, when the hydrolysable groups represented by X″ are all alkoxy groups, e.g. methoxy groups, this particular polyfluoropolyether silane has the following general formula: CF₃—CF₂—CF₂—(O—CF₂—CF₂—CF₂)_{b}—O—CF₂—CF₂—CH₂—O—CH₂—CH₂—CH₂—Si—(OCH₃)₃. Alternatively, when the hydrolysable groups represented by X″ are all alkylamino groups, e.g. N(CH₃)₂ groups, this particular polyfluoropolyether silane has the following general formula: CF₃—CF₂—CF₂—(O—CF₂—CF₂—CF₂)_{b}—O—CF₂—CF₂—CH₂—O—CH₂—CH₂—CH₂—Si—(N(CH₃)₂)₃. In these embodiments, subscript b is typically an independently selected integer from 17 to 25.

In another embodiment of the composition in which Y in general formula (C) is F and Z in general formula (C) is —(CF₂)—, as described above, subscripts c, d, f and g in general formula (C) are 0 and subscripts b, e, h, n, m, i and j in general formula (C) are each independently an integer greater than 0. As but one example of this embodiment, subscript a′ is 3, subscript b is at least 1, subscript e is 1, subscript h is 1, X′ is an oxygen atom, subscript n is 3, subscript m and i are each 1, and subscript j is 2. In this one example, the polyfluoropolyether silane has the following general formula: CF₃—CF₂—CF₂—(O—CF₂—CF₂—CF₂)_{b}—O—CF₂—CF₂—CH₂—O—CH₂—CH₂—CH₂—Si(CH₃)₂—O—Si(CH₃)₂—CH₂—CH₂—Si—(X″)_{3-z}(R²)_{z}. Thus, when the hydrolysable groups represented by X″ are all alkoxy groups, e.g. methoxy groups, and z is 0, this particular polyfluoropolyether silane has the following general formula: CF₃—CF₂—CF₂—(O—CF₂—CF₂—CF₂)_{b}—O—CF₂—CF₂—CH₂—O—CH₂—CH₂—CH₂—Si(CH₃)₂—O—Si(CH₃)₂—CH₂—CH₂—Si(OCH₃)₃. In these embodiments, subscript b is typically an independently selected integer from 17 to 25.

In another embodiment of the composition in which Y in general formula (C) is F, as introduced above, Z in general formula (C) is —(CF(CF₃)CF₂O)—. In this embodiment, subscripts b, c, d, e and g in general formula (C) are 0, and subscripts f, h and n in general formula (C) are each independently an integer greater than 0. As but one example of this embodiment, subscripts b, c, d, e and g in general formula (C) are 0, subscript a′ is at least 1, subscript f is 1, subscript h is 1, X′ is an oxygen atom, subscript n is 3, and subscripts i, m and j are each 0. In this one example, the polyfluoropolyether silane has the following general formula: F—(CF(CF₃)—CF₂—O)_{a′}—CF(CF₃)—CH₂—O—CH₂—CH₂—CH₂—Si—(X″)_{3-z}(R²)_{z}. Thus, when the hydrolysable groups represented by X″ are all alkoxy groups, e.g. methoxy groups, and z is 0, this particular polyfluoropolyether silane has the following general formula: F—(CF(CF₃)—CF₂—O)_{a′}—CF(CF₃)—CH₂—O—CH₂—CH₂—CH₂—Si—(OCH₃)₃. Alternatively, when the hydrolysable groups represented by X″ are all alkylamino groups, e.g. N(CH₃)₂ groups, this particular polyfluoropolyether silane has the following general formula: F—(CF(CF₃)—CF₂—O)_{a′}—CF(CF₃)—CH₂—O—CH₂—CH₂—CH₂—Si—(N(CH₃)₂)₃. In these embodiments, subscript a′ is typically an independently selected integer from 14 to 20.

In another embodiment of the composition in which Y in general formula (C) is F and Z in general formula (C) is —(CF(CF₃)CF₂O)—, as introduced immediately above, subscripts b, c, d, e and g in general formula (C) are 0, subscript a′ is at least 1, subscript f is 1, subscript h is 1, X′ is an oxygen atom, subscript n is 3, subscript m and i are each 1, and subscript j is 2. In this one example, the polyfluoropolyether silane has the following general formula: F—(CF(CF₃)CF₂O)_{a′}—CF(CF₃)—CH₂—O—CH₂—CH₂—CH₂—Si(CH₃)₂—O—Si(CH₃)₂—CH₂—CH₂—Si—(X″)_{3-z}(R²)_{z}. Thus, when the hydrolysable groups represented by X″ are all alkoxy groups, e.g. methoxy groups, and z is 0, this particular polyfluoropolyether silane has the following general formula: F—(CF(CF₃)CF₂O)_{a′}—CF(CF₃)—CH₂—O—CH₂—CH₂—CH₂—Si(CH₃)₂—O—Si(CH₃)₂—CH₂—CH₂—Si(OCH₃)₃. In these embodiments, subscript a′ is typically an independently selected integer from 14 to 20.

In other embodiments of the composition, Y in general formula (C) is Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—. Typically, when Y in general formula (C) is Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—, subscripts b, c and f in general formula (C) are 0. As such, in these embodiments, when the groups represented by subscripts b, c and f are absent, the polyfluoropolyether silane has the following general formula: Y—Z_{a′}—[(OCF₂CF(CF₃))_{d}—(OC₂F₄)ₑ—(OCF₂)_{g}]—(CH₂)ₕ—X′—(CₙH₂ₙ)—((SiR¹₂—O)ₘ—SiR¹₂)ᵢ—(CⱼH₂ⱼ)—Si—(X″)_{3-z}(R²)_{z}.

In one embodiment in which Y in general formula (C) is Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—, as introduced immediately above, Z is —(CF₂)—, X′ is an oxygen atom, subscripts b, c, d and f in general formula (C) are 0, and subscripts e and g in general formula (C) are each independently an integer greater than 0. As but one example of this embodiment, Z is —(CF₂)—, X′ is an oxygen atom, subscripts b, c, d, f, m, i and j in general formula (C) are 0, subscript e is at least 1, subscript g is at least 1, subscript h is 1, X′ is an oxygen atom, and n is 3. In this one example, the polyfluoropolyether silane has the following general formula: (R²)_{z}(X″)_{3-z}Si—CH₂—CH₂—CH₂—O—CH₂—CF₂—(OCF₂CF₂)ₑ—(OCF₂)_{g}—CH₂—O—CH₂—CH₂—CH₂—Si—(X″)_{3-z}(R²)_{z}. Thus, when the hydrolysable groups represented by X″ are all alkoxy groups, e.g. methoxy groups, and z is 0, this particular polyfluoropolyether silane has the following general formula: (CH₃O)₃Si—CH₂—CH₂—CH₂—O—CH₂—CF₂—(OCF₂CF₂)ₑ—(OCF₂)_{g}—CH₂—O—CH₂—CH₂—CH₂—Si—(OCH₃)₃. Alternatively, when the hydrolysable groups represented by X″ are all alkylamino groups, e.g. N(CH₃)₂ groups, and z is 0, this particular polyfluoropolyether silane has the following general formula: ((CH₃)₂N)₃Si—CH₂—CH₂—CH₂—O—CH₂—CF₂—(OCF₂CF₂)ₑ—(OCF₂)_{g}—CH₂—O—CH₂—CH₂—CH₂—Si—(N(CH₃)₂)₃.

Alternatively, in another embodiment in which Y in general formula (C) is Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—, as introduced above, Z is —(CF₂)—, X′ is an oxygen atom, subscripts b, c, e and f in general formula (C), and subscripts d and g in general formula (C) are each independently an integer greater than 0.

The polyfluoropolyether silane is typically present in the composition in an amount of from 0.01 to 0.5, alternatively from 0.05 to 0.35, alternatively from 99.7 to 99.9, percent by weight based on the total weight of the composition. The amount of the solvent may vary from the ranges set forth immediately above contingent on the absence or presence of various optional components employed in the composition, as described in greater detail below.

Catalysts may optionally be utilized to promote surface modification by the composition. These catalysts promote the reaction between the hydrolysable groups of the polyfluoropolyether silane and the surface of the article. These catalysts can be used individually or as a combination of two or more in the composition. Examples of suitable catalytic compounds include acids, such as carboxylic acid, e.g. formic acid, acetic acid, propionic acid, butyric acid, and/or valeric acid; bases; metal salts of organic acids, such as dibutyl tin dioctoate, iron stearate, and/or lead octoate; titanate esters, such as tetraisopropyl titanate and/or tetrabutyl titanate; chelate compounds, such as acetylacetonato titanium; silazanes, such as hexamethyl disilazane and/or divinyltetramethyl disilazane; silanes, such as tetrakis(dimethylamine)silane and/or aminopropyltrimethoxysilane, and the like. If utilized, the catalysts are typically utilized in an amount of from greater than 0 to 5, alternatively 0.01 to 2, percent by weight, based on 100 parts by weight of the composition.

The composition may additionally include any suitable other component(s) such as a coupling agent, an antistatic agent, an ultraviolet absorber, a plasticizer, a leveling agent, a pigment, a catalyst and so on.

As set forth above, the present invention further provides a surface-treated article and a method of preparing a surface-treated article, which are described collectively in greater detail below.

The surface-treated article comprises an article presenting a surface. A layer is deposited on the surface of the article. The layer is formed from the composition, which is applied on the surface of the article to prepare the surface-treated article. Although the article may be any article, because of the excellent physical properties obtained from the composition of the present invention, the article is typically an electronic article, an optical article, consumer appliances and components, automotive bodies and components, etc. Most typically, the article is an article for which it is desirable to reduce stains and/or smudges resulting from fingerprints or skin oils.

Examples of electronic articles typically include those having electronic displays, such as LCD displays, LED displays, OLED displays, plasma displays, etc. These electronic displays are often utilized in various electronic devices, such as computer monitors, televisions, smart phones, GPS units, music players, remote controls, portable readers, etc. Exemplary examples of electronic articles include those having interactive touch-screen displays or other components which are often in contact with the skin and which oftentimes display stains and/or smudges.

As introduced above, the article may also be a metal article, such as consumer appliances and components. Exemplary articles include a dishwasher, a stove, a microwave, a refrigerator, a freezer, etc., which typically have a glossy metal appearance, such as stainless steel, brushed nickel, etc.

Alternatively, the article may be an automotive body or component. For example, the composition may be applied directly on a top coat of an automobile body to form the layer, which imparts the automobile body with a glossy appearance, which is aesthetically pleasing and resists stains, such as dirt, etc., as well as smudges from fingerprints.

Examples of suitable optical articles include inorganic materials, such as glass plates, glass plates comprising an inorganic layer, ceramics, and the like. Additional examples of suitable optical articles include organic materials, such as transparent plastic materials and transparent plastic materials comprising an inorganic layer, etc. Specific examples of optical articles include antireflective films, optical filters, optical lenses, eyeglass lenses, beam splitters, prisms, mirrors, etc.

Examples of inorganic materials include glass plates. Examples of inorganic compounds for forming glass plates comprising an inorganic layer include metal oxides (silicon oxides, such as silicon dioxide, silicon monoxide, etc.), magnesium oxide, titanium oxide, tin oxide, zirconium oxide, sodium oxide, antimony oxide, indium oxide, bismuth oxide, yttrium oxide, cerium oxide, zinc oxide, ITO (indium tin oxide) and the like.

The inorganic layer or inorganic material comprising such an inorganic compound may be single- or multi-layered. The inorganic layer acts as an antireflective layer, and can be formed by known methods, such as wet coating methods. Examples of wet coating methods include dip coating, spin coating, flow coating, spray coating, roll coating, gravure coating, die coating, and like methods.

Among organic materials, examples of transparent plastic materials include materials comprising various organic polymers. From the view point of transparency, refractive index, dispersibility and like optical properties, and various other properties such as shock resistance, heat resistance and durability, materials used as optical members usually comprise polyolefins (polyethylene, polypropylene, etc.), polyesters (polyethylene terephthalate, polyethylene naphthalate, etc.), polyamides (nylon 6, nylon 66, etc.), polystyrene, polyvinyl chloride, polyimides, polyvinyl alcohol, ethylene vinyl alcohol, acrylics, celluloses (triacetylcellulose, diacetylcellulose, cellophane, etc.), or copolymers of such organic polymers. It is to be appreciated that these materials may be utilized in ophthalmic elements. Non-limiting examples of ophthalmic elements include corrective and non-corrective lenses, including single vision or multi-vision lenses like bifocal, trifocal and progressive lenses, which may be either segmented or non-segmented, as well as other elements used to correct, protect, or enhance vision, including without limitation contact lenses, intra-ocular lenses, magnifying lenses and protective lenses or visors. Preferred material for ophthalmic elements comprises one or more polymers selected from polycarbonates, polyamides, polyimides, polysulfones, polyethylene terephthalate and polycarbonate copolymers, polyolefins, especially polynorbornenes, diethylene glycol-bis(allyl carbonate) polymers—known as CR39—and copolymers, (meth)acrylic polymers and copolymers, especially (meth)acrylic polymers and copolymers derived from bisphenol A, thio(meth)acrylic polymers and copolymers, urethane and thiourethane polymers and copolymers, epoxy polymers and copolymers, and episulfide polymers and copolymers.

In addition to such optical articles, the composition of the invention can be applied to form the layer on other articles, such as window members for automobiles or airplanes, thus providing advanced functionality. To further improve surface hardness, it is also possible to perform surface modification by a so-called sol-gel process using a combination of the composition and TEOS (tetraethoxysilane).

The step of applying the composition on the surface of the article to form the layer typically comprises a wet coating method.

Specific examples of wet coating methods suitable for the method include dip coating, spin coating, flow coating, spray coating, roll coating, gravure coating, slot coating, and like methods.

Once the layer is formed on the surface of the article from the composition, the layer may further undergo heating, humidification, catalytic post treatment, photoirradiation, electron beam irradiation, etc.

Typically, the thickness of the layer formed from the composition is from 1 to 5,000, alternatively 1 to 200, alternatively 1-20, alternatively 1 to 10, nm.

As noted above, layers formed from the composition have a desirable appearance that is generally free from undesirable streaks, which are prevalent in layers formed from conventional compositions. Layers formed from conventional compositions are generally washed and/or rinsed with a solvent, which may be the same as or different from the solvent employed in the conventional compositions, to minimize such streaking. Notably, such rinsing of conventional layers formed from conventional compositions also adversely affects, i.e., detrimentally weakens, abrasion resistance of such conventional layers. Accordingly, in certain embodiments, the method of preparing the surface-treated article is free from the step of washing the layer on the surface of the article with a solvent, which reduces costs and processing steps associated with the formation of the layer, and also minimizes or eliminates the reduction of abrasion resistance generally attributable to such rinsing.

Additionally, layers formed from the composition have excellent durability relative to layers formed from conventional compositions including conventional solvents.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The following examples are intended to illustrate the invention and are not to be viewed in any way as limiting to the scope of the invention.

### EXAMPLES

Compositions are prepared in accordance with the subject disclosure. In particular, each of the compositions described below comprises a solvent and a polyfluoropolyether silane. Unless otherwise indicated, any percentages set forth below relate to weight percentages.

### Practical Example 1

TABLE 1
Practical Example 1

| Component | Amount (wt %) |
|---|---|
| Polyfluoropolyether Silane 1 | 0.2 |
| Solvent 1 | 99.8 |

Polyfluoropolyether Silane 1 has the following general formula: CF₃—CF₂—CF₂—(O—CF₂—CF₂—CF₂)_{b}—O—CF₂—CF₂—CH₂—O—CH₂—CH₂—CH₂—Si—(OCH₃)₃, where b is an integer from 17 to 25.

Solvent 1 is a mixture of two nitrogen-containing perfluorinated solvents. In particular, solvent 1 comprises a mixture of C₁₂F₂₇N and C₉F₂₁N. In the former compound, each substituent is C₄F₉, whereas in the latter compound, one substituent is CF₃ and two substituents are C₄F₉.

### Practical Example 2

TABLE 2
Practical Example 2

| Component | Amount (wt %) |
|---|---|
| Polyfluoropolyether Silane 2 | 0.199 |
| Solvent 1 | 99.794 |
| Additive Compound 1 | 0.007 |

Polyfluoropolyether Silane 2 is has the following general formula: F—(CF(CF₃)CF₂O)_{a′}—CF(CF₃)—CH₂—O—CH₂—CH₂—CH₂—Si(CH₃)₂—O—Si(CH₃)₂—CH₂—CH₂—Si(OCH₃)₃, where a′ is an integer from 14 to 20.

Additive Compound I is aminopropyl triethoxysilane.

### Practical Example 3

TABLE 3
Practical Example 3

| Component | Amount (wt %) |
|---|---|
| Polyfluoropolyether Silane 1 | 0.50 |
| Solvent 2 | 95.50 |

Solvent 2 is a perfluoropolyether solvent having a boiling point temperature of about 170° C. and having the following general formula:

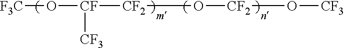

wherein m′ is an integer ≧1 and n′ is ≧0 so as to provide an average molecular weight of about 760 Da.

### Comparative Example 1

TABLE 4
Comparative Example 1

| Component | Amount (wt %) |
|---|---|
| PolyfluoropolyetherSilane 1 | 0.2 |
| Comparative Solvent 1 | 99.8 |

Comparative Solvent 1 is a conventional solvent comprising ethyl nonafluoroisobutyl ether and ethyl nonafluorobutyl ether.

### Comparative Example 2

TABLE 5
Comparative Example 2

| Component | Amount (wt %) |
|---|---|
| Polyfluoropolyether Silane 1 | 0.2 |
| Comparative Solvent 2 | 99.8 |

Comparative Solvent 2 is a perfluoropolyether solvent having a boiling point temperature of about 110° C. and having the following general formula:

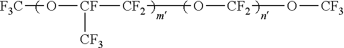

wherein m′ is an integer ≧1 and n′ is ≧0 so as to provide an average molecular weight of about 580 Da.

### Comparative Example 3

TABLE 6
Comparative Example 3

| Component | Amount (wt %) |
|---|---|
| Polyfluoropolyether Silane 2 | 0.199 |
| Comparative Solvent 2 | 99.595 |
| Additive Compound 1 | 0.007 |
| Carrier Solvent | 0.199 |

The respective compositions of Practical Examples 1-3 and Comparative Examples 1-3 are each applied to a surface of a substrate via spray coating. In particular, these compositions are applied to a glass substrate via a PVA-1000 dispensing machine having an atomization pressure of 1 psi, a liquid pressure of 5 psi, a stroke of from 2 mil, a nozzle height of 5.3 cm, and a speed of about 20,000 countssec. Once the respective compositions were applied to the substrates, the compositions were cured at room temperature for about 24 hours to form layers on the substrates.

Physical properties of the layers formed from the compositions are measured. In particular, physical properties of the respective layers are measured before and after subjecting the layers to an abrasion resistance test, as described below.

The abrasion resistance test utilizes a reciprocating abraser—Model 5900, which is commercially available from Taber Industries. The abrading material utilized was a CS-10 Wearaser® from Taber Industries of North Tonawanda, N.Y. The abrading material has dimensions of 6.5 mm×12.2 mm. The reciprocating abraser is operated for 25 cycles at a speed of 25 cycles per minute with a stroke length of 1 inch and a load of 7.5 N.

The water contact angle (WCA) of each of the layers is measured via a VCA Optima XE goniometer, which is commercially available from AST Products, Inc., Billerica, Mass. The water contact angle measured is a static contact angle based on a 2 μL droplet on each of the layers. The water contact angle is measured before (designated as “initial” in Table 7 below) and after (designated as “final” in Table 7 below) the abrasion resistance test. Before the abrasion resistance test, the appearance of each of the layers is visually inspected to determine whether the appearance is acceptable, i.e., free from streaking and/or spotting, or unacceptable, i.e., having significant streaking and/or spotting.

The physical properties of these layers formed from spray coating are set forth below in Table 7.

TABLE 7

| | |
|---|---|
| Surface Rinse | WCA |

| Example: | Apperance | Required | Initial | Final |
|---|---|---|---|---|
| Practical | Pass | No | 116.1 | 114.3 |
| Example 1 | | | | |
| Practical | Pass | No | 115.5 | 108.8 |
| Example 2 | | | | |
| Practical | Pass | No | 116.7 | 113.8 |
| Example 3 | | | | |
| Comparative | Fail | Yes | 116.5 | 107.3 |
| Example 1 | | | | |
| Comparative | Fail | Yes | 116.2 | 108.2 |
| Example 2 | | | | |
| Comparative | Fail | Yes | 125.8 | 98.1 |
| Example 3 | | | | |

The respective compositions of Practical Examples 1-3 and Comparative Examples 1-3 are each also applied to a surface of a substrate via flow coating. In particular, these compositions are applied to a glass substrate that has been rinsed with acetone via a pipette. More specifically, the glass substrates are held vertically, and the compositions are applied across a major surface of the glass substrates via the pipette, and the major surface of the glass substrates becomes coated with the compositions via gravity. The layers are formed from drying and curing the glass substrates while being held vertically for about 24 hours to form layers on the substrates.

The physical properties of these layers formed from flow coating are set forth below in Table 8.

TABLE 8

| | |
|---|---|
| Surface Rinse | WCA |

| Example: | Apperance | Required | Initial | Final |
|---|---|---|---|---|
| Practical | Pass | No | 116.3 | 114 |
| Example 1 | | | | |
| Practical | Pass | No | 116.3 | 105 |
| Example 2 | | | | |
| Practical | Pass | No | 114.4 | 114.5 |
| Example 3 | | | | |
| Comparative | Fail | Yes | 116 | 106.1 |
| Example 1 | | | | |
| Comparative | Fail | Yes | 116.1 | 102.1 |
| Example 2 | | | | |
| Comparative | Fail | Yes | 123.2 | 97.6 |
| Example 3 | | | | |

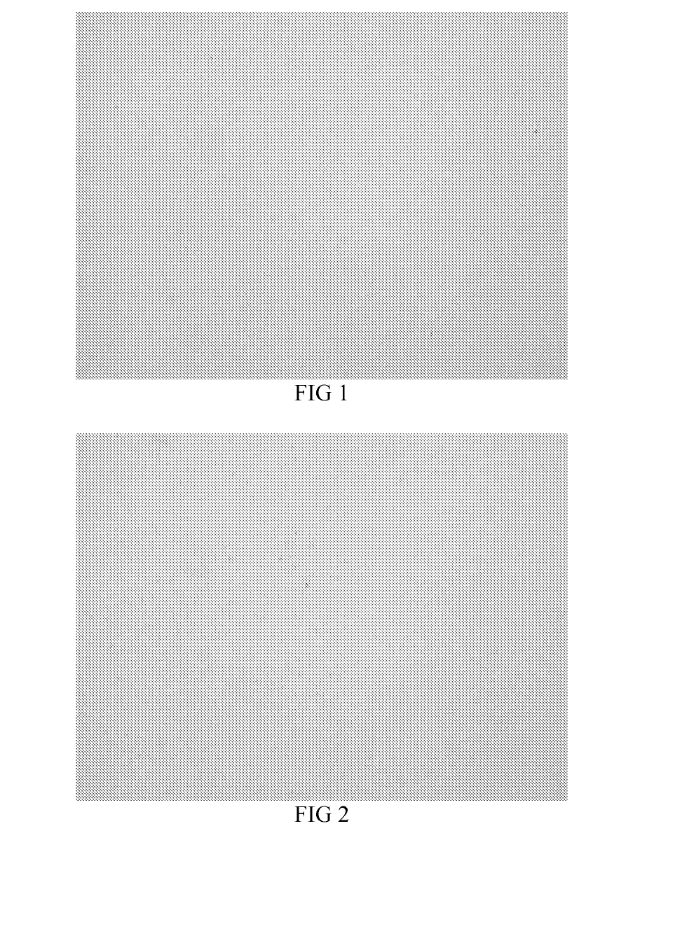

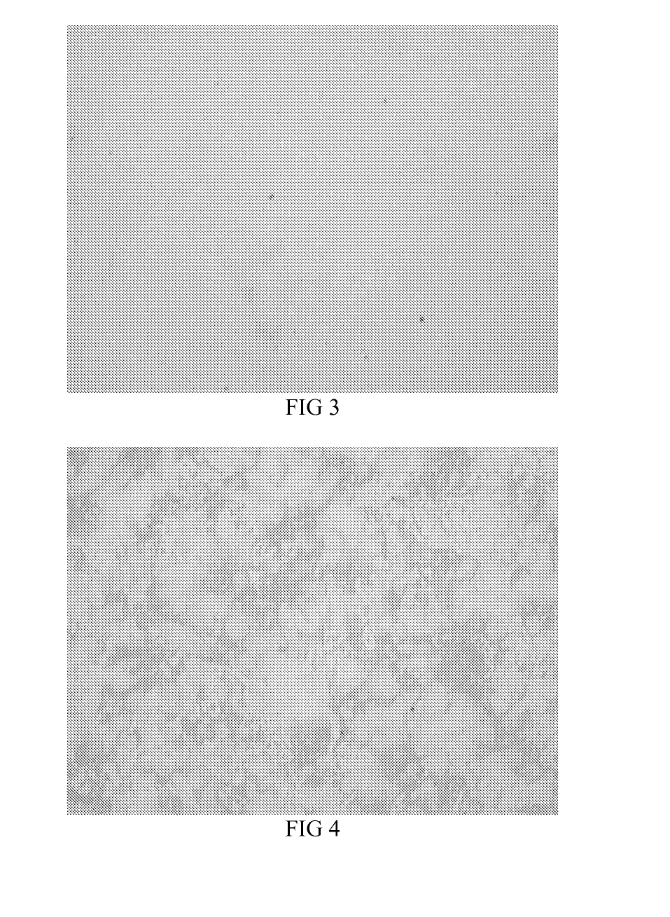

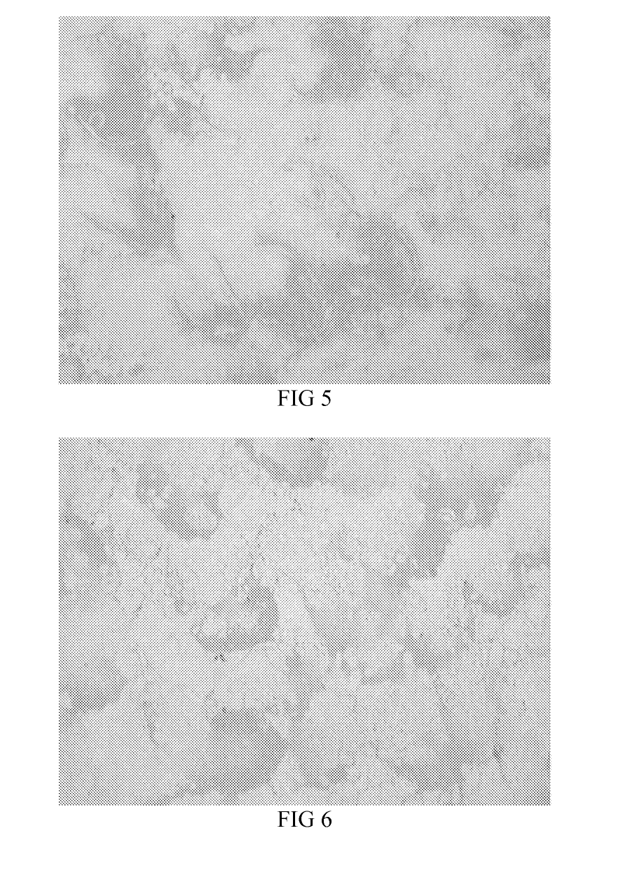

Relative to the appearance of the respective layers, FIG. 1 is a microscopic image of a layer formed from Practical Example 1 at 37.5× magnification. FIG. 2 is a microscopic image of a layer formed from Practical Example 2 at 37.5× magnification. FIG. 3 is a microscopic image of a layer formed from Practical Example 3 at 37.5× magnification. As clearly illustrated in FIGS. 1-3, the layers formed from Practical Examples 1-3 had an excellent appearance generally free from spotting and streaks. Conversely, FIG. 4 is a microscopic image of a layer formed from Comparative Example 1 at 37.5× magnification. FIG. 5 is a microscopic image of a layer formed from Comparative Example 2 at 37.5× magnification. FIG. 6 is a microscopic image of a layer formed from Comparative Example 3 at 37.5× magnification. As clearly illustrated in FIGS. 4-6, the conventional layers formed from Comparative Examples 1-3 undesirably had spotting and streaks.

Notably, Practical Example 1 and Comparative Example 1 are identical but for the particular solvents utilized, yet FIG. 1 clearly illustrates the advantageous effects of the solvent of Practical Example 1 relative to that of Comparative Example 1, as illustrated in FIG. 4. Similarly, Practical Example 2 and Comparative Example 3 are identical but for the particular solvents utilized, yet FIG. 2 clearly illustrates the advantageous effects of the solvent of Practical Example 2 relative to that of Comparative Example 3, as illustrated in FIG. 6.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

1. A composition for surface treatment comprising:
a perfluorinated solvent having at least one CF₃ group, said solvent selected from the group consisting of:
a perfluoropolyether solvent having a boiling point temperature of at least 120° C. at atmospheric pressure and having the following general formula (A); 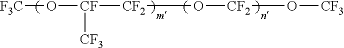
wherein m′ is an integer 1 and n′ is 0; and
a nitrogen-containing perfluorinated solvent having the following general formula (B): 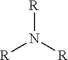
wherein each R is an independently selected perfluorinated hydrocarbon group having from 1 to 10 carbon atoms;
and combinations thereof; and
a polyfluoropolyether silane having the following general formula (C): Y—Z_{a′}—[(OC₃F₆)_{b}—(OCF(CF₃)CF₂)_{c}—(OCF₂CF(CF₃))_{d}—(OC₂F₄)ₑ—(CF(CF₃))_{f}—(OCF₂)_{g}]—(CH₂)ₕ—X′—(CₙH₂ₙ)—((SiR¹₂—O)ₘ—SiR¹₂)ᵢ—(CⱼH₂ⱼ)—Si—(X″)_{3-z}(R²)_{z};
wherein Z is independently selected from —(CF₂)—, —(CF(CF₃)CF₂O)—, —(CF₂CF(CF₃)O)—, —(CF(CF₃)O)—, —(CF(CF₃)CF₂)—, —(CF₂CF(CF₃))—, and —(CF(CF₃))—; a′ is an integer from 1 to 200; b, c, d, e, f, and g are integers each independently selected from 0 to 200; h, n and j are integers each independently selected from 0 to 20; i and m are integers each independently selected from 0 to 5; X′ is a bivalent organic group or an oxygen atom; R¹ is an independently selected C₁-C₂₂ hydrocarbon group; z is an integer independently selected from 0 to 2; X″ is an independently selected hydrolysable group; R² is an independently selected C₁-C₂₂ hydrocarbon group which is free of aliphatic unsaturation; and Y is selected from F and Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—; wherein X″, X′, z, R¹, R², j, m, i, n and h are as defined above;
provided that when subscript i is 0, subscript j is also 0; when subscript i is an integer greater than 0, subscript j is also an integer greater than 0; and when subscript i is an integer greater than 0, m is also an integer greater than 0.

2. The composition of claim 1 wherein said solvent comprises said perfluoropolyether solvent.

3. The composition of claim 1 wherein said solvent comprises said nitrogen-containing perfluorinated solvent.

4. The composition of claim 3 wherein each R of said nitrogen-containing perfluorinated solvent independently has from 3 to 5 carbon atoms.

5. The composition of claim 1 wherein said hydrolysable group represented by X″ in general formula (C) of said polyfluoropolyether silane is independently selected from a halide group, —OR³, —NHR³, —NR³R⁴, —OOC—R³, O—N═CR³R⁴, O—C(═CR³R⁴)R⁵, and —NR³COR⁴, wherein R³, R⁴ and R⁵ are each independently selected from H and a C₁-C₂₂ hydrocarbon group, and wherein R³ and R⁴ optionally can form a cyclic amine in the alkylamino group.

6. The composition of claim 1 wherein said solvent is present in said composition in an amount of from 95 to 99.99 percent by weight based on the total weight of said composition and said polyfluoropolyether silane is present in said composition in an amount of from 0.01 to 0.5 percent by weight based on the total weight of said composition.

7. A method of preparing a surface-treated article, said method comprising:
applying a composition for surface treatment on a surface of an article to form a layer on the surface of the article from the composition; and
wherein the composition comprises:
a perfluorinated solvent having at least one CF₃ group, the solvent selected from the group consisting of:
a perfluoropolyether solvent having a boiling point temperature of at least 120° C. at atmospheric pressure and having the following general formula (A); 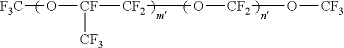
wherein m′ is an integer 1 and n′ is 0;
a nitrogen-containing perfluorinated solvent having the following general formula (B): 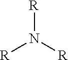
wherein each R is an independently selected perfluorinated hydrocarbon group having from 1 to 10 carbon atoms;
and combinations thereof; and
a polyfluoropolyether silane having the following general formula (C):
Y—Z_{a′}—[(OC₃F₆)_{b}—(OCF(CF₃)CF₂)_{c}—(OCF₂CF(CF₃))_{d}—(OC₂F₄)ₑ—(CF(CF₃))_{f}—(OCF₂)_{g}]—(CH₂)ₕ—X′—(CₙH₂ₙ)—((SiR¹₂—O)ₘ—SiR¹₂)ᵢ—(CⱼH₂ⱼ)—Si—(X″)_{3-z}(R²)_{z};
wherein Z is independently selected from —(CF₂)—, —(CF(CF₃)CF₂O)—, —(CF₂CF(CF₃)O)—, —(CF(CF₃)O)—, —(CF(CF₃)CF₂)—, —(CF₂CF(CF₃))—, and —(CF(CF₃))—; a′ is an integer from 1 to 200; b, c, d, e, f, and g are integers each independently selected from 0 to 200; h, n and j are integers each independently selected from 0 to 20; i and m are integers each independently selected from 0 to 5; X′ is a bivalent organic group or an oxygen atom; R¹ is an independently selected C₁-C₂₂ hydrocarbon group; z is an integer independently selected from 0 to 2; X″ is an independently selected hydrolysable group; R² is an independently selected C₁-C₂₂ hydrocarbon group which is free of aliphatic unsaturation; and Y is selected from F and Si—(X″)_{3-z}(R²)_{z}(CⱼHI₂ⱼ)—((SiR¹₂—O)ₘ—SiR¹₂)ᵢ—(CₙH₂ₙ)—X′—(CH₂)ₕ—; wherein X″, X′, z, R¹, R², j, m, i, n and h are as defined above;
provided that when subscript i is 0, subscript j is also 0; when subscript i is an integer greater than 0, subscript j is also an integer greater than 0;
and when subscript i is an integer greater than 0, m is also an integer greater than 0.

8. The method of claim 7 free from the step of washing the layer on the surface of the article with a solvent.

9. The method of claim 7 wherein the step of applying the composition is selected from dip coating, spin coating, flow coating, spray coating, roll coating, gravure coating, sputtering, slot coating, atmospheric pressure plasma, and combinations thereof.

10. The method of claim 7 wherein the solvent comprises the perfluoropolyether solvent.

11. The method of claim 7 wherein the solvent comprises the nitrogen-containing perfluorinated solvent.

12. The method of claim 11 wherein each R of the nitrogen-containing perfluorinated solvent independently has from 3 to 5 carbon atoms.

13. The method of claim 7 wherein the hydrolysable group represented by X′ in general formula (C) of the polyfluoropolyether silane is independently selected from a halide group, —OR³, —NHR³, —NR³R⁴, —OOC—R³, O—N═CR³R⁴, O—C(═CR³R⁴)R⁵, and —NR³COR⁴, wherein R³, R⁴ and R⁵ are each independently selected from H and a C₁-C₂₂ hydrocarbon group, and wherein R³ and R⁴ optionally can form a cyclic amine in the alkylamino group.

14. The method of claim 7 wherein the solvent is present in the composition in an amount of from 95 to 99.99 percent by weight based on the total weight of the composition and the polyfluoropolyether silane is present in the composition in an amount of from 0.01 to 0.5 percent by weight based on the total weight of the composition.

15. A surface treated article formed in accordance with the method of claim 7.
